(19) United States
(12) Patent Application Publication
(10) Pub. No.: US 2014/0207712 A1
(43) Pub. Date: Jul. 24, 2014

(54) Classifying Based on Extracted Information

(71) Applicant: HEWLETT-PACKARD DEVELOPMENT COMPANY, L.P., Houtson, TX (US)

(72) Inventors: Maria Teresa Gonzalez Diaz, Palo Alto, CA (US); Andrey Simanovskiy, St. Petersburg (RU); Cipriano A. Santos, Palo Alto, CA (US); Fernando Orozco, Tlaquepaque (MX); Shailendra K. Jain, Palo Alto, CA (US); Alberto De Obeso Orendain, Guadalajara (MX); Mildreth AlcarazMejia, Tlaquepaque (MX); Victor ZaldivarCarrillo, Thaquepaque (MX); Alan GarciaRodriguez, Thaquepaque (MX)

(73) Assignee: Hewlett-Packard Development Company, L.P., Houtson, TX (US)

(21) Appl. No.: 13/746,805

(22) Filed: Jan. 22, 2013

(51) Int. Cl. G06N 99/00; G06F 17/30

(52) U.S. Cl. CPC G06N 99/005; G06F 17/30495
USPC 706/12; 707/758

(57) ABSTRACT

Information may be extracted from a document. A new pattern may be identified in the document. Classification may be performed based on the extracted information.

### RELATED APPLICATIONS

This application is related to PCT/US08/81803, entitled “Supply and Demand Consolidation in Employee Resource Planning” by Gonzalez et al., filed on Oct. 30, 2008, and to PCT/US09/54035, entitled “Scoring a Matching Between a Resource and a Job” by Gonzalez et al., filed on Aug. 17, 2009, both of which are incorporated by reference in their entirety.

### BACKGROUND

Managing information can be difficult, and it will inevitably become more difficult as the amount of available information increases. Not only should information be stored and maintained properly, it is advantageous to know what information you have and how it relates to your needs. For example, enterprises constantly have human resource needs. However, selecting the right candidate for a position can be a daunting task, especially if there are a large number of candidates. Whether an enterprise is searching within or outside the organization, the enterprise generally has various forms of information about the candidates available to it. For instance, it is quite common for the enterprise to have a resume for each candidate.

### BRIEF DESCRIPTION OF DRAWINGS

The following detailed description refers to the drawings, wherein:

FIG. 1 illustrates a system to extract information from a document associated with a person and classify the person based on the information, according to an example.

FIG. 2 illustrates a system to match candidates with positions, according to an example.

FIG. 3 illustrates an example of generating a profile based on a resume, according to an example.

FIG. 4 illustrates a method of extracting information from a document associated with a person and classifying the person based on the information, according to an example.

FIG. 5 illustrates a computer-readable medium for extracting information from a document associated with a person and classifying the person based on the information, according to an example.

### DETAILED DESCRIPTION

Finding an appropriate match between a candidate and a position can be challenging. Ensuring that the candidate is qualified to fill the position is an important consideration. However, it can be difficult to determine which candidates are best qualified when faced with a large number of candidates for a particular position. This quandary can arise when attempting to fill an open position by hiring an external candidate or promoting an internal candidate. It may also arise when determining the appropriate employee(s) to staff on a particular project.

According to an embodiment, a computing system (e.g., a resource planning system) can include an information extractor to identify entities in a document associated with a person and extract attributes from the entities. The document (e.g., a resume) may contain unstructured information. The extracted entities may be chunks of text corresponding to a recognized pattern. The patterns may be stored in a knowledge base. The attributes extracted from the entities may include various information, such as skills, roles, experience level, industry domain, and the like. Furthermore, the attributes may be associated with chronological information, such as an amount of time spent in a certain role or developing a certain skill.

The system may also include an adaptive learner to identify a new pattern in an unrecognized entity in the document. The unrecognized entity may be a chunk of text that does not correspond to any known pattern in the knowledge base. In some cases, the unrecognized entity may be a small, unrecognized chunk of text within a larger, recognized chunk of text. For example, a chunk of text identified as listing programming language capabilities may include a particular programming language that is unrecognizable by the information extractor. If the adaptive learner is able to learn a new pattern, the new pattern may be added to the knowledge base so that the information extractor may identify entities and extract attributes based on the new pattern. In the example of an unrecognized entity being a programming language, the adaptive learner may be able to determine based on the context (e.g., the placement of the unrecognized entity within a larger, recognized entity) that the unrecognized entity is a type of programming language, and may add it to the knowledge base.

The system may additionally include a resource classifier to associate the person with a plurality of classes based on the attributes. The plurality of classes may correspond to position requirements, such as industry domain, technical knowledge, experience level, prerequisite roles, or the like. Furthermore, the system may include a scorer to compute a score for the person for each of the plurality of classes. Each score may represent a degree of fit for the respective class. The system may also include a resource matcher to match candidates with appropriate positions. For example, the resource matcher may identify a match between a candidate and a position based on the plurality of classes associated with the candidate.

This exemplary system may have numerous advantages. For instance, appropriate matches between qualified candidates and open positions may be made with ease, even when the number of candidates is extremely large. This can relieve the burden on hirers. Furthermore, the system can ensure a more objective evaluation of candidate skills vis-á-vis the position requirements, which can result in a more equal consideration of all candidates and can result in a better match for the position. Additionally, the system may enable better management of a large workforce and can help ensure that an enterprise's resources are capitalized on and utilized. Further details of this embodiment and associated advantages, as well as of other embodiments, will be discussed in more detail below with reference to the drawings.

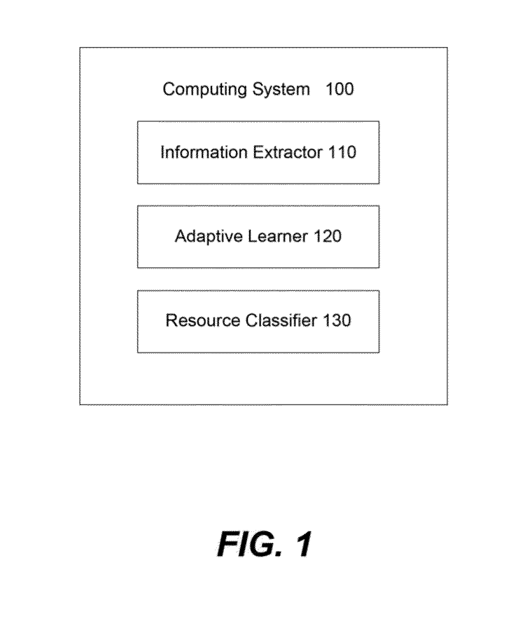

Referring now to the drawings, FIG. 1 illustrates a system to extract information from a document associated with a person and classify the person based on the information, according to an example. Computing system 100 may include and/or be implemented by one or more computers. For example, the computers may be server computers, workstation computers, desktop computers, or the like. The computers may include one or more controllers and one or more machine-readable storage media.

A controller may include a processor and a memory for implementing machine readable instructions. The processor may include at least one central processing unit (CPU), at least one semiconductor-based microprocessor, at least one digital signal processor (DSP) such as a digital image processing unit, other hardware devices or processing elements suitable to retrieve and execute instructions stored in memory, or combinations thereof. The processor can include single or multiple cores on a chip, multiple cores across multiple chips, multiple cores across multiple devices, or combinations thereof. The processor may fetch, decode, and execute instructions from memory to perform various functions. As an alternative or in addition to retrieving and executing instructions, the processor may include at least one integrated circuit (IC), other control logic, other electronic circuits, or combinations thereof that include a number of electronic components for performing various tasks or functions.

The controller may include memory, such as a machine-readable storage medium. The machine-readable storage medium may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium can be computer-readable and non-transitory. Additionally, computing system 100 may include one or more machine-readable storage media separate from the one or more controllers.

Computing system 100 may include information extractor 110, adaptive learner 120, and resource classifier 130. Each of these components may be implemented by a single computer or multiple computers. The components may include software modules, one or more machine-readable media for storing the software modules, and one or more processors for executing the software modules. A software module may be a computer program comprising machine-executable instructions.

In addition, users of computing system 100 may interact with computing system 100 through one or more other computers, which may or may not be considered part of computing system 100. As an example, a user may interact with system 100 via a computer application residing on system 100 or on another computer, such as a desktop computer, workstation computer, tablet computer, or the like. The computer application can include a user interface.

The functionality implemented by information extractor 110, adaptive learner 120, and resource classifier 130 may be part of a larger software platform, system, application, or the like. For example, these components may be part of a resource planning or resource management software application.

Information extractor 110 may be configured to identify entities in a document and extract attributes from the entities. The document may include unstructured information. Unstructured information is information that does not have a pre-defined data model and/or does not fit well into relational tables. For example, unstructured information may include large sections of text that does not follow a pre-defined format. Unstructured information can thus be difficult for a computer to process. For example, the document may be a resume or curriculum vitae. The document may be associated with a person, such as a job candidate. For example, the document may be a resume of a job candidate.

The entities identified by information extractor 110 may be portions of the document that correspond with a recognized pattern. For example, information extractor 110 may be configured to compare chunks of information in the document to patterns stored in a knowledge base. The knowledge base may include patterns as well as inference rules associated with the patterns. The inference rules may define relationships between data in the information chunks. For example, the knowledge base may be in the form of an ontology.

An ontology may represent knowledge as a set of concepts within a domain, and the relationships between pairs of concepts. It can be used to model a domain and support reasoning about entities. Ontologies may take various forms. There are programming languages for encoding ontologies, called ontology languages. However, those of skill in the art could create an ontology using programming languages that are not special ontology languages.

As a simplified example for illustrative purposes, an ontology may be represented in a tree-like structure. A node in the ontology may be labeled “technical skills”. The node may have various child nodes. One child node may be labeled “programming languages”. The “programming languages” node may in turn include child nodes for each programming language currently known/recognized by the system 100. For instance, child nodes may be labeled “C#”, “C++”, “Java”, “JavaScript”, and the like. Accordingly, the concept that “C#” is a programming language and, more generally, a technical skill, is thus represented by the ontology.

The connections between nodes, and the relationship applied by those connections (e.g., a concept represented by a parent node encompasses a concept represented by a child node of the parent node), may correspond to inference rules. Other examples of inference rules that may be represented in the ontology are association, equivalence, and dependence. These rules can be useful since the terminology used in resumes to identify related, similar, or identical concepts often differs.

The ontology may be generated manually, automatically, or both. For example, a programmer or resource management specialist may manually create the ontology beforehand and store it in the knowledge base for use by the system. The ontology may also be automatically created through a machine learning process based on structured data, such as a relational database storing information regarding an industry, technical information, and/or common resume information and patterns. Furthermore, as described later, the ontology may be updated automatically if new information or patterns are encountered in a document being processed.

If a chunk of information follows a known pattern (a pattern stored in the knowledge base), that chunk of information may be identified as a recognized entity. One or more inference rules corresponding to the pattern may then be applied to the recognized entity to extract attributes from the entity. Attributes extracted from the entities may include various information, such as skills, roles, experience level, industry domain, and the like. The attributes may have varying levels of granularity. For example, a more general attribute extracted from a resume may be that the candidate has proficiency in computer programming. A more specific attribute may be that the candidate has proficiency in certain programming languages, such as C# and Java.

Information extractor 110 may further be configured to extract chronological information related to the attributes. A resume may include chronological information in many forms. For example, a resume may indicate how many years the candidate held a particular position. A resume may also include statements that include chronological information. For instance, the resume may include a statement such as the following: “More than 20 years of experience programming in C++” or “Java Developer in 2008”. The knowledge base may include patterns and inference rules for recognizing and processing such chronological information to enable the information extractor 110 to extract the information and relate it to the candidate's attributes. For example, information extractor 110 may associate the number of years a candidate was at a position with the skills or roles associated with that position. Similarly, based on the first example statement above, information extractor 110 may associate the chronological information “20 years” with extracted attributes for “programmer”, “programming languages”, and/or “C++”. This may be considered to be duration information. Information extractor 110 may also extract how recent a particular role, skill, or the like, was practiced. For instance, based on the second example statement above, information extractor 110 may associate the year 2008 (or a specific range of years, if so indicated in the resume) with the extracted attribute “Java developer”. This may be considered to be recentness information. Recentness information may be important because more recent roles, skills, experience, and the like may be considered by an employer to be more relevant than roles, skills, and experience from many years ago.

Adaptive learner 120 may dynamically update the knowledge base by discovering new information and patterns from documents. It can be used to both build and update the ontology. For example, adaptive learner 120 may be configured to identify a new pattern in an unrecognized entity in the document. For example, if a chunk of information does not follow a known pattern, that chunk of information may be identified as an unrecognized entity. The adaptive learner 120 may perform various algorithms, such as learning algorithms, to attempt to determine the meaning of the unrecognized entity. The adaptive learner 120 can leverage the existing ontology to attempt to learn the meaning of the unrecognized entity.

As an example, suppose a resume contains a section labeled “Languages”, which includes all of the programming languages that the candidate has experience with. However, the current ontology may not have a node labeled “languages”. Accordingly, this information chunk may be considered to be an unrecognized entity by the information extractor 110. The adaptive learner 120 may be configured to examine each word within this information chunk to determine whether there are recognized entities within the information chunk. (Alternatively, the adaptive learner 120 can cause information extractor 110 to perform this examination and report the results back to the adaptive learner 120.) If the adaptive learner 120 identifies known entities within the chunk, the adaptive learner can use the inference rules to determine the meaning of the heading of the information chunk. For instance, if the majority of the words within this section relate to programming languages, the adaptive learner 120 may infer that “languages” is a synonym for “programming languages” and may add this relationship as a new pattern. For example, the adaptive learner 120 may add a node to the ontology labeled “languages” and may make it equivalent to the node labeled “programming languages”, such that languages has the same relationships to the rest of the ontology as “programming languages”. Of course, “languages” may also represent communication languages, such as English, Spanish, and the like. Accordingly, over time the ontology would likely be updated with appropriate connections, inference rules, and the like, to include this second meaning of “languages”.

If a new patter is learned, the new pattern may be added to the knowledge base, such as to the ontology. The information extractor may then use the new pattern to extract additional attributes from the previously unrecognized entity.

Resource classifier 130 may be configured to associate a person (e.g., a candidate) associated with a processed document (e.g., a resume) with a plurality of classes based on the extracted attributes. The plurality of classes may correspond to position requirements. The position requirements may be employer-specified requirements for a particular position that the employer is trying to fill. The requirements may be characteristics, expertise, skill level, duration information, recentness information, and the like, that the employer is looking for in a candidate. For example, position requirements may include industry domain (e.g., information technology, electrical engineering, manufacturing, healthcare), technical knowledge, experience level, prerequisite roles, or the like. Resource classifier may also be configured to associate any extracted chronological information with the class corresponding to the attribute(s) previously associated with the chronological information.

The plurality of classes may be stored in the knowledge base. Furthermore, the plurality of classes may be represented in the ontology, to enable correspondence between the attributes and the classes. Alternatively, a separate ontology, or the like, may be created linking the classes to potential attributes from the ontology used by information extractor 110. In yet another example, an employer may specify classes based on the attributes represented by the ontology, so that no translation between classes and attributes is needed.

Resource classifier 130 may create or update a profile for each candidate based on each candidate's resume. For example, resource classifier 130 may add all classes that a candidate is classified in to the candidate's profile. Accordingly, the profile may indicate whether a candidate meets specified position requirements. Thus, without having individually reviewed each resume, the employer may have an initial picture of which candidates likely meet the requirements for a position.

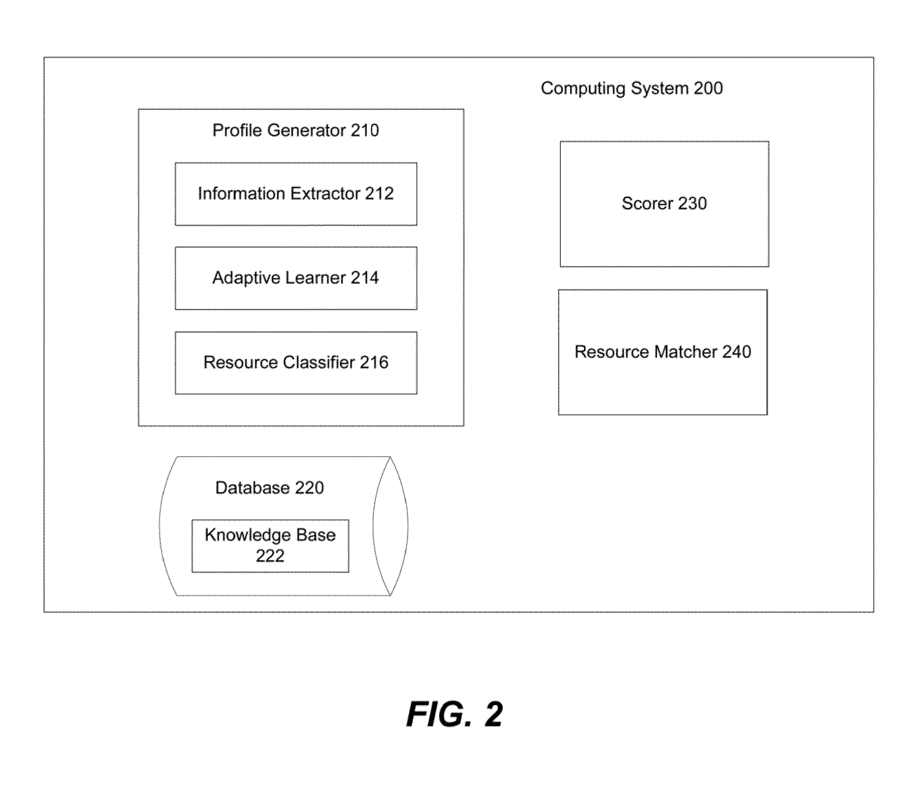

FIG. 2 illustrates a system to match candidates with positions, according to an example. Computing system 200 may include and/or be implemented by one or more computers. For example, the computers may be server computers, workstation computers, desktop computers, or the like. The computers may include one or more controllers and one or more machine-readable storage media. The one or more controllers and machine-readable storage media may be as described above with reference to computing system 100.

Computing system 200 may include profile generator 210, database 220, scorer 230, and resource matcher 240. Each of these components may be implemented by a single computer or multiple computers. The components may include software modules, one or more machine-readable media for storing the software modules, and one or more processors for executing the software modules. A software module may be a computer program comprising machine-executable instructions.

In addition, users of computing system 200 may interact with computing system 200 through one or more other computers, which may or may not be considered part of computing system 200. As an example, a user may interact with system 200 via a computer application residing on system 200 or on another computer, such as a desktop computer, workstation computer, tablet computer, or the like. The computer application can include a user interface.

The functionality implemented by profile generator 210, database 220, scorer 230, and resource matcher 240 may be part of a larger software platform, system, application, or the like. For example, these components may be part of a resource planning or resource management software application.

Profile generator 210 may be similar to computing system 100. In particular, information extractor 212, adaptive learner 214, and resource classifier 216 may have similar functionality as information extractor 110, adaptive learner 120, and resource classifier 130.

Database 220 may be implemented by various database technology and may include one or more computer-readable storage media. Knowledge base 222 may be a portion of database 220. Knowledge base 222 may include information and be implemented as described above. For example, knowledge base 222 may include an ontology. Database 220 may include other information, data structure, and the like, for implementing profile generator 210, scorer 230, and resource matcher 240. For example, database 220 may include the job requirements and/or classes for classification.

Scorer 230 may compute a score for each class associated with a person in the person's profile. Each score may represent a degree of fit for the respective class. The score may be computed based on how well the person matches a particular position requirement associated with the class. For example, a position requirement may be “10 years of experience programming in Java”. Scorer 230 may be configured to divide the number of years of experience of the candidate by 10 years. Accordingly, if the person has only 8 years of experience programming in Java, the person may receive a score of 80%. As another example, a position requirement may be “experience programming in Java within the past 2 years”. Accordingly, a candidate that does not have Java programming experience within the past 2 years may receive a score of 0%. If the candidate were to have some Java experience more than 2 years ago, a scorer 230 may have a scoring algorithm/methodology that assigns a score based on how many years ago the experience was. For instance, the scoring methodology may assign a sliding scale score for some Java experience within the past 10 years, such that experience within the past 2 years receives a score of 100%, experience more than 10 years ago receives a score of 0%, but experience within the range of more than 2 years ago to 10 years ago receives some percentage of 100. As yet another example, a position requirement may be “experience programming cloud technology”. In this example, the position requirement may be harder to quantify. Scorer 230 may nonetheless be configured with certain rules for determining how well a candidate meets this requirement. For example, the number of programming language associated with cloud technology may be used as a gauge of this skill. As another example, whether the resume mentions the term “cloud” may be figured into the score.

In some cases, a score may not be calculated. For example, some classifications may be met or not. For instance, an employer may simply require that a candidate be familiar with certain programming languages. Accordingly, mention of these programming languages in the candidate's resume may be sufficient for the classification. In addition, sometimes it may be determined that there is no satisfactory way to calculate an accurate score.

Resource matcher 240 may match candidates with appropriate positions. For example, the resource matcher may identify a match between a candidate and a position based on the plurality of classes associated with the candidate as well as the respective score for each classification. Resource matcher 240 may be configured to identify a certain number of candidates as matches, for example, the top five candidates. The employer may then choose to interview these matches to see whether any of them would be a good fit for the position.

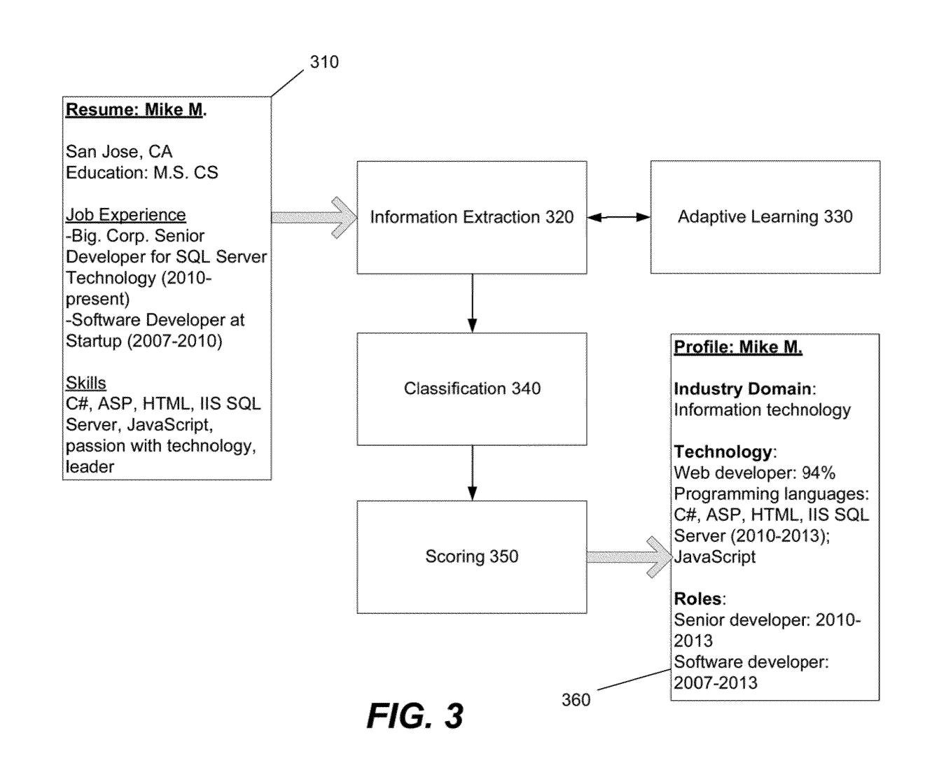

FIG. 3 illustrates a simplified example of generating a profile based on a resume. Block 310 represents a resume of a candidate named Mike. M. The resume may be parsed and information may be extracted at block 320. For example, information extractor 212 may perform this task. If there are any unrecognized entities, adaptive learning may occur at block 330. For example, adaptive learner 214 may perform this task. If a new pattern is learned, information extraction may continue at block 320 based on the new pattern.

After information extraction is complete, Mike M. may be classified into a plurality of classes at block 340. For example, resource classifier 216 may perform this task. As can be seen in Mike M.'s profile 360, Mike M. is classified into the “information technology” industry domain. This classification may be made due to his degree in Computer Science and his programming experience. In the technology category, Mike M. is classified as a “web developer”. This classification may be made based on his experience with programming languages used in web development, such as HTML and JavaScript.

Mike M. also receives classifications in a number of programming languages, which can be based off his listing of the programming languages in the skills section of his resume. Additionally, Mike M.'s programming language experience in IIS SQL Server is associated with the duration and recentness information of 2010-2013. This association is made based on the relationship in his resume between his job experience at Big Corp. and the time information 2010-2013.

In the roles category, Mike M. is classified as a “senior developer” and a “software developer”, which can be based off the mention of these roles in the job experience section of his resume. Additionally, each of these roles is associated with the corresponding duration and recentness information.

After classification, Mike M. may receive a score for one or more of his classifications at block 350. For example, scorer 230 may perform this task. As can be seen in profile 360, Mike M. received a score only for the “web developer” classification.

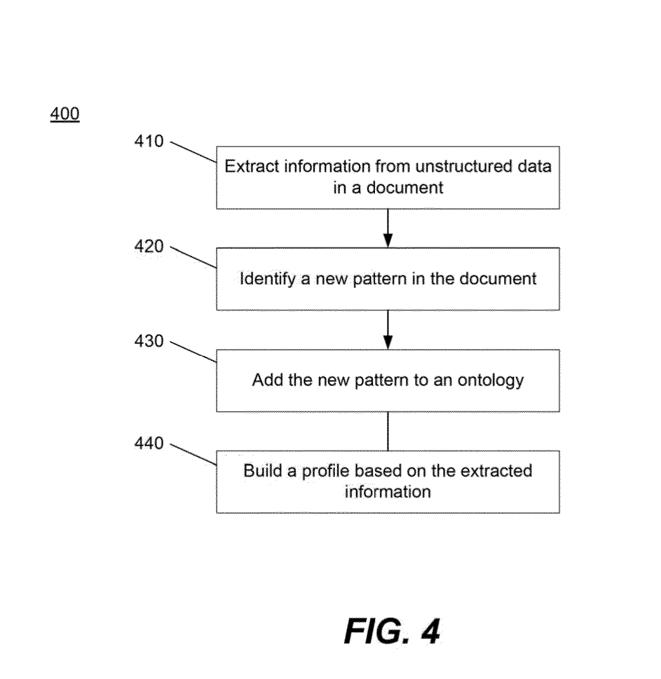

FIG. 4 illustrates a method of extracting information from a document associated with a person and classifying the person based on the information, according to an example. Method 400 may be performed by a computing device, system, or computer, such as system 100, system 300, or computer 500. Computer-readable instructions for implementing method 400 may be stored on a computer readable storage medium. These instructions as stored on the medium may be called modules and may be executed by a computer. All of the functionality described above may be stored on a medium and executed by a computer. Furthermore, method 400 should be interpreted in conjunction with the description of similar functionality above.

At 410, information may be extracted from unstructured data in a document. For example, the document may be a resume and the information may include attributes, such as skills. The information may be extracted based on an ontology. At 420, a new pattern may be identified in the document that is not found in the ontology. At 430, the new pattern may be added to the ontology. Accordingly, information may then be extracted based on the new pattern. At 440, a profile may be built based on the extracted information. The profile may include classifications based on the extracted information. The classifications may be determined based on the relationship of the extracted information to the ontology. The classifications may be related to position requirements.

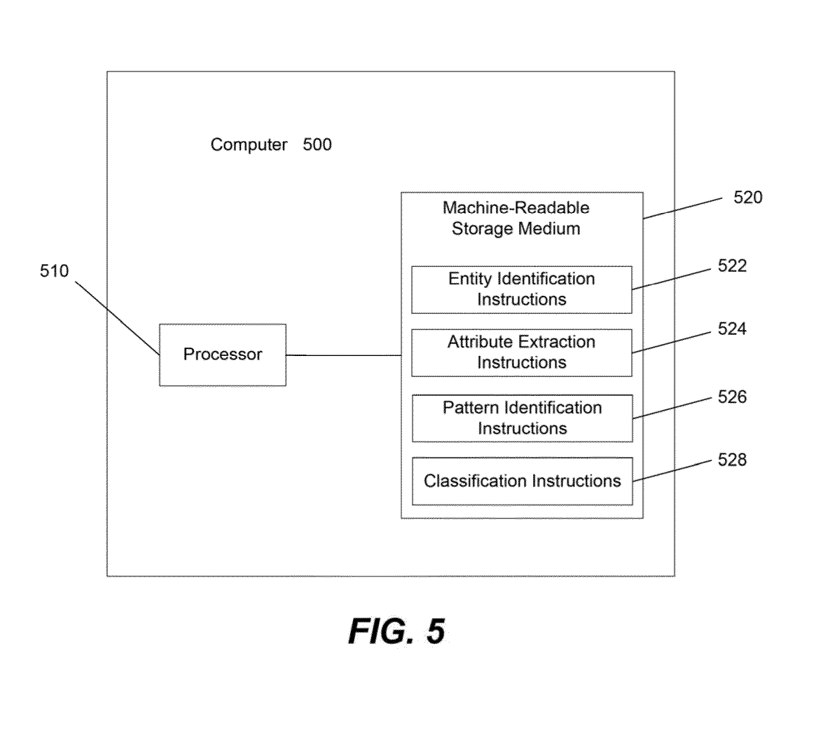

FIG. 5 illustrates a computer-readable medium for extracting information from a document associated with a person and classifying the person based on the information, according to an example. Computer 500 may be any of a variety of computing devices or systems, such as described with respect to computing system 100 or 300.

Processor 510 may be at least one central processing unit (CPU), at least one semiconductor-based microprocessor, other hardware devices or processing elements suitable to retrieve and execute instructions stored in machine-readable storage medium 520, or combinations thereof. Processor 510 can include single or multiple cores on a chip, multiple cores across multiple chips, multiple cores across multiple devices, or combinations thereof. Processor 510 may fetch, decode, and execute instructions 522, 524, 526, 528 among others, to implement various processing. As an alternative or in addition to retrieving and executing instructions, processor 510 may include at least one integrated circuit (IC), other control logic, other electronic circuits, or combinations thereof that include a number of electronic components for performing the functionality of instructions 522, 524, 526, 528. Accordingly, processor 510 may be implemented across multiple processing units and instructions 522, 524, 526, 528 may be implemented by different processing units in different areas of computer 500.

Machine-readable storage medium 520 may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium 520 can be computer-readable and non-transitory. Machine-readable storage medium 520 may be encoded with a series of executable instructions for managing processing elements.

The instructions 522, 524, 526, 528 when executed by processor 510 (e.g., via one processing element or multiple processing elements of the processor) can cause processor 510 to perform processes, for example, method 400, and variations thereof. Furthermore, computer 500 may be similar to computing system 100 or 300 and may have similar functionality and be used in similar ways, as described above. For example, entity identification instructions 522 can cause processor 510 to identify entities in a resume associated with a person. Attribute extraction instructions 524 can cause processor 510 to extract attributes from the identified entities. Pattern identification instructions 526 can cause processor 510 to identify a new pattern in an unrecognized entity in the resume. Classification instructions 528 can cause processor 510 to classify the person into multiple classes based on the attributes. The classes may be associated with position requirements.

What is claimed is:

1. A computing system, comprising:
an information extractor to identify entities in a document associated with a person and extract attributes from the entities;
an adaptive learner to identify a new pattern in an unrecognized entity in the document, wherein the information extractor is configured to extract additional attributes from the unrecognized entity based on the new pattern; and
a resource classifier to associate the person with a plurality of classes based on the attributes and additional attributes.

2. The computing system of claim 1, wherein the document includes unstructured data.

3. The computing system of claim 2, wherein the document is a resume.

4. The computing system of claim 1, wherein the information extractor is configured to identify entities by comparing information chunks in the document to patterns stored in a knowledge base.

5. The computing system of claim 4, wherein the knowledge base includes inference rules associated with the patterns to define relationships between data in the information chunks.

6. The computing system of claim 4, wherein the adaptive learner is configured to add the new pattern to the knowledge base, and the information extractor is configured to extract the additional attributes based on the new pattern added to the knowledge base.

7. The computing system of claim 1, wherein the information extractor is configured to extract chronological information related to the attributes, and the resource classifier is configured to associate the chronological information with the plurality of classes.

8. The computing system of claim 7, wherein the extracted chronological information comprises duration information.

9. The computing system of claim 7, wherein the extracted chronological information comprises recentness information.

10. The computing system of claim 1, wherein the information extractor is configured to extract attributes from the entities using an ontology.

11. The computing system of claim 1, further comprising a scorer to compute a score for the person for each of the plurality of classes, the score representing a degree of fit for the respective class.

12. The computing system of claim 1, further comprising a resource matcher to identify a match between the person and a position based on the plurality of classes associated with the person.

13. A method comprising:
extracting information from unstructured data in a document based on an ontology;
identifying a new pattern in the document not found in the ontology;
adding the new pattern to the ontology; and
building a profile based on the extracted information, wherein the profile includes classifications based on the extracted information.

14. The method of claim 13, wherein the document is a resume and the extracted information includes skills.

15. The method of claim 13, further comprising extracting additional information from the document based on the new pattern.

16. The method of claim 13, wherein the classifications are determined based on the relationship of the extracted information to the ontology.

17. A non-transitory computer-readable storage medium comprising instructions that, when executed by a processor, cause the processor to:
identify entities in a resume associated with a person;
extract attributes from the entities;
identify a new pattern in an unrecognized entity in the resume; and
classify the person into multiple classes based on the attributes, wherein the classes are associated with position requirements.
